(19) United States
(12) Patent Application Publication
(10) Pub. No.: US 2005/0091610 A1
(43) Pub. Date: Apr. 28, 2005

(54) Selective display of windows on an auxiliary output device

(75) Inventors: Scott Douglas Frei, Rochester, MN (US); Gregory Richard Hintermeister, Rochester, MN (US); Steven Paul Jones, Rochester, MN (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/691,290

(22) Filed: Oct. 22, 2003

(51) Int. Cl. G06F 3/00

(52) U.S. Cl. 715/804; 715/781; 715/811; 715/817; 715/818; 715/825; 715/841

(57) ABSTRACT

A method, apparatus, system, and signal-bearing medium that in an embodiment select a subset of windows displayed on an output device for display via an auxiliary output device, e.g., a projector. In various embodiments, the selection of the subset is based on a group affiliation or based on a list of allowed or disallowed applications. In other embodiments, the image on the auxiliary output device is selectively frozen or displays a pre-set image while the image on the output device changes. In this way, the displayed content on the auxiliary output device is selectively controlled, which allows for a more effective presentation.

### FIELD

This invention generally relates to computers and more specifically relates to the selective display of windows on an auxiliary output device.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

One important use of computer systems is to manage presentations made via connecting a computer to a projector, which is commonly a device that converts computer signals into light for projection onto a screen that can be viewed by an audience. The computer typically treats the projector as an auxiliary display device and sends all information that is displayed on the computer's desktop or primary display device also to the projector. Often the presenter will use a presentation program (e.g., Microsoft PowerPoint) that generates slides, which are analogous to foils or transparencies, which were the presentation technique used before the advent of computers. Since the presentation program displays the slides on the desktop of the computer, the slides can also be seen via the projector. While sending all information on the desktop of the primary display to the projector is a simple and easy design, it has several disadvantages.

First, viewing all of the information on the desktop can be annoying and distracting for the audience. For example, the audience may only be interested in seeing the slides that are output from the presentation program, but the presenter may also have other applications running in support of the presentation. For example, the presenter may also wish to have a word processing program running in order to view notes or a script for the presentation.

Second, the presenter may need some time at the beginning of the presentation to start up the presentation program, some time at the end to close the presentation program, or may need to restart the presentation program in the middle of the presentation in case of an error. In all these examples, the projector may be connected, which allows the audience to see the presenter's desktop complete with all the presenter's icons and the presenter's wallpaper, which at best is distracting for the audience and at worst might include confidential or personal information.

Finally, instant messaging has become a common computer application that people use to communicate in near real time. If during a presentation, the presenter receives an instant message and the entire desktop is being sent to the projector, the audience sees the instant message. The instant message may contain confidential or personal information, which may be embarrassing or create an unprofessional image.

Without a better way to handle presentations, presenters and audiences will continue to suffer from distraction, annoyance, and embarrassment.

### SUMMARY

A method, apparatus, system, and signal-bearing medium are provided that in an embodiment select a subset of windows displayed on an output device for display via an auxiliary output device, e.g., a projector. In various embodiments, the selection of the subset is based on a group affiliation or based on a list of allowed or disallowed applications. In other embodiments, the image on the auxiliary output device is selectively frozen or displays a pre-set image while the image on the output device changes. In this way, the displayed content on the auxiliary output device is selectively controlled, which allows for a more effective presentation.

### BRIEF DESCRIPTION OF THE DRAWINGS

FIG. 1 depicts a block diagram of an example system for implementing an embodiment of the invention.

FIG. 2 depicts a pictorial representation of an example user interface, according to an embodiment of the invention.

FIG. 3 depicts a block diagram of an example data structure for group data, according to an embodiment of the invention.

FIG. 4 depicts a flowchart of example processing for a presentation controller, according to an embodiment of the invention.

FIG. 5 depicts a flowchart of further example processing for a presentation controller, according to an embodiment of the invention.

FIG. 6A depicts a pictorial representation of an example user interface for a divide function, according to an embodiment of the invention.

FIG. 6B depicts a pictorial representation of an example user interface for a toggle function, according to an embodiment of the invention.

FIG. 7 depicts a block diagram of an example data structure for application data, according to an embodiment of the invention.

FIG. 8 depicts a flowchart of example processing for a presentation controller, according to an embodiment of the invention.

### DETAILED DESCRIPTION

In an embodiment a subset of windows displayed on an output device are selected for display via an auxiliary output device, e.g., a projector. As used herein, a “window” is a portion of a screen or display device that can display information. In various embodiments a window may represent the output of an application, a document, a view of a document, a field, a message, a dialog, or any portion thereof. In various embodiments, the selection of the subset is based on a group affiliation or based on a list of allowed or disallowed applications. In other embodiments, the image on the auxiliary output device is selectively frozen or displays a pre-set image while the image on the output device changes. In this way, the displayed content on the auxiliary output device is selectively controlled, which allows for a more effective presentation.

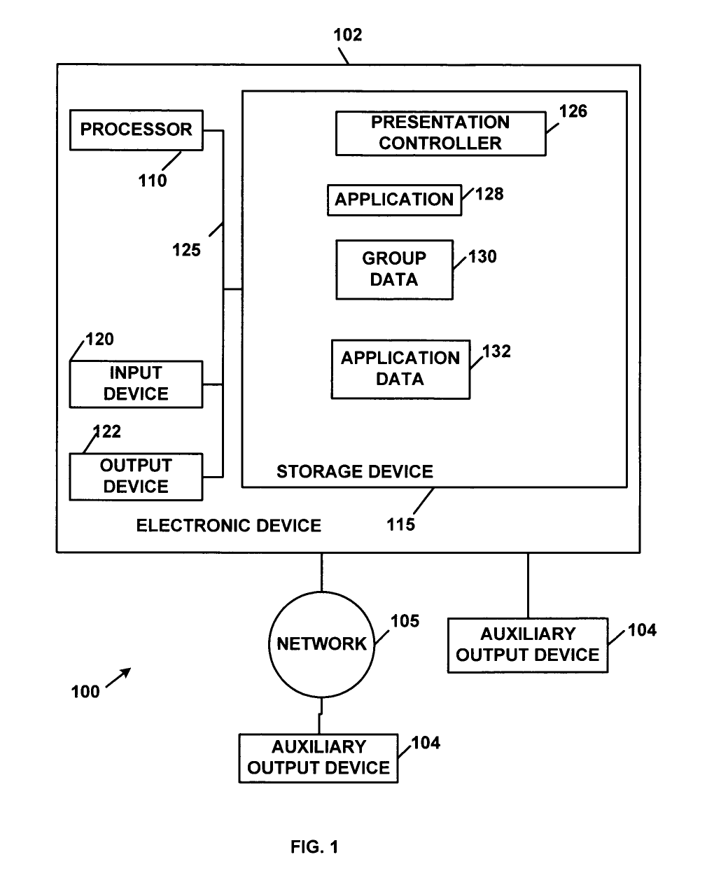

Referring to the Drawing, wherein like numbers denote like parts throughout the several views, FIG. 1 depicts a block diagram of an example system 100 for implementing an embodiment of the invention. The system 100 includes an electronic device 102 connected to an auxiliary output device(s) 104 either directly or indirectly, e.g., via a network 105. In other embodiments, any number of electronic devices 102, auxiliary output devices 104, and networks 105 may be present. Although the electronic device 102, the auxiliary output devices 104, and the network 105 are illustrated in FIG. 1 as being discrete, separate components, in other embodiments some or all of their functions and elements may be combined.

The electronic device 102 includes a processor 110, a storage device 115, an input device 120, and an output device 122, all connected directly or indirectly via a bus 125. The processor 110 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 110 executes instructions and includes that portion of the electronic device 102 that controls the operation of the entire electronic device. Although not depicted in FIG. 1, the processor 110 typically includes a control unit that organizes data and program storage in memory and transfers data and other information between the various parts of the electronic device 102. The processor 110 reads and/or writes code and data to/from the storage device 115, the network 105, the input device 120, and/or the output device 122. Although the electronic device 102 is drawn to contain only a single processor 110 and a single bus 125, embodiments of the present invention apply equally to electronic devices that may have multiple processors and multiple buses with some or all performing different functions in different ways.

The storage device 115 represents one or more mechanisms for storing data. For example, the storage device 115 may include read only memory (ROM), random access memory (RAM), magnetic disk storage media, optical storage media, flash memory devices, and/or other machine-readable media. In other embodiments, any appropriate type of storage device may be used. Although only one storage device 115 is shown, multiple storage devices and multiple types of storage devices may be present. Although the storage device 115 is shown in FIG. 1 as a single monolithic entity, the storage device 115 may in fact be distributed and/or hierarchical, as is known in the art. For example, the storage device 115 may exist in multiple levels of storage devices, and these levels of storage devices may be further divided by function, so that one level of storage device holds, e.g., instructions while another holds, e.g., non-instruction data which is used by the processor or processors. The storage device 115 may further be distributed and associated with different processors or sets of processors, as is known in any of various so-called non-uniform memory access (NUMA) computer architectures. Further, although the electronic device 102 is drawn to contain the storage device 115, it may be distributed across other electronic devices, such as electronic devices connected to the network 105.

The storage device 115 includes a presentation controller 126, an application 128, group data 130, and application data 132, all of which may in various embodiments have any number of instances. Although the presentation controller 126, the application 128, the group data 130, and the application data 132 are all illustrated as being contained within the storage device 115 in the electronic device 102, in other embodiments some or all of them may be on different electronic devices and may be accessed remotely, e.g., via the network 105.

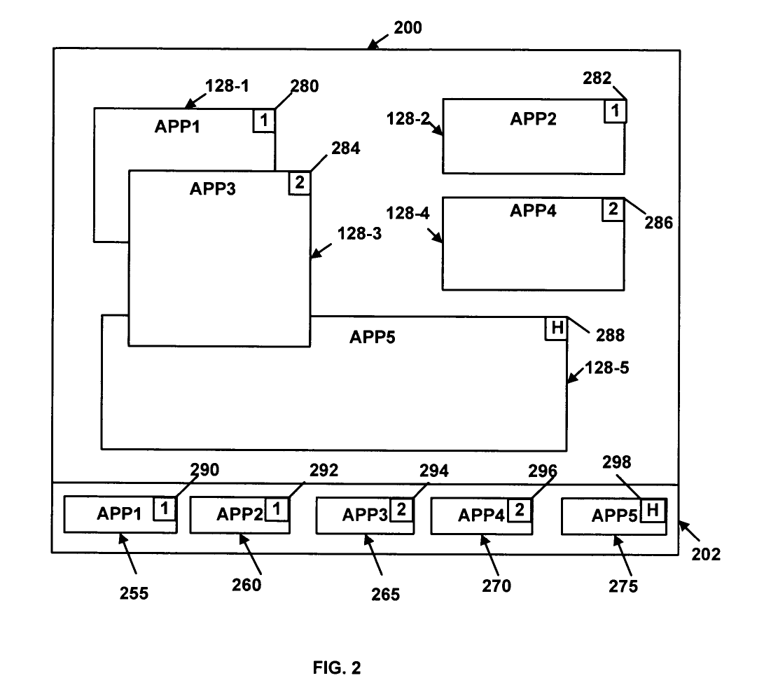

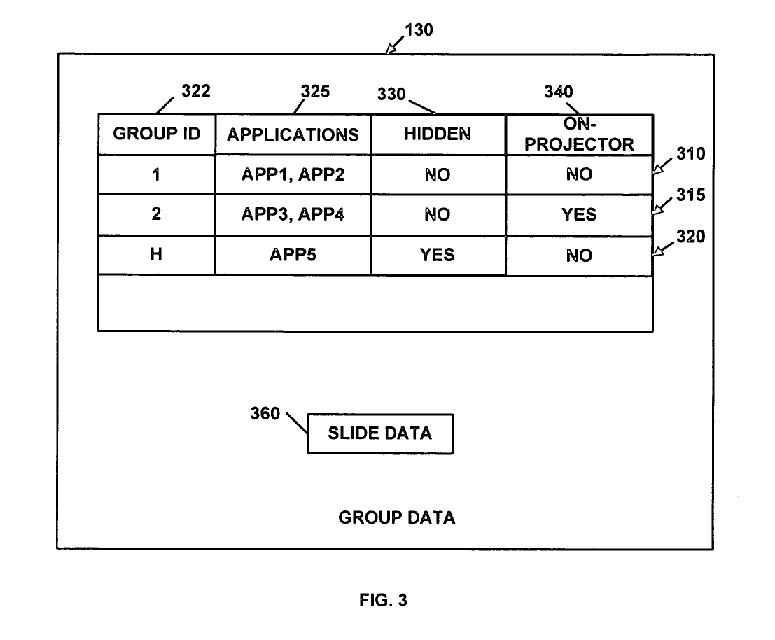

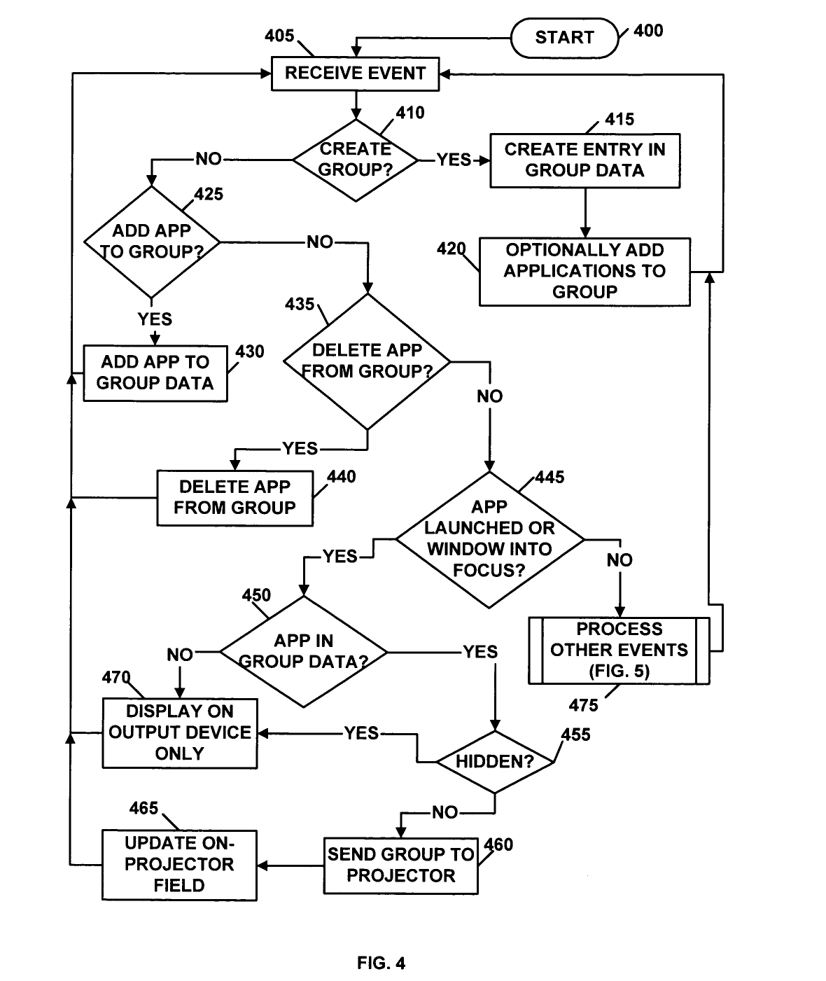

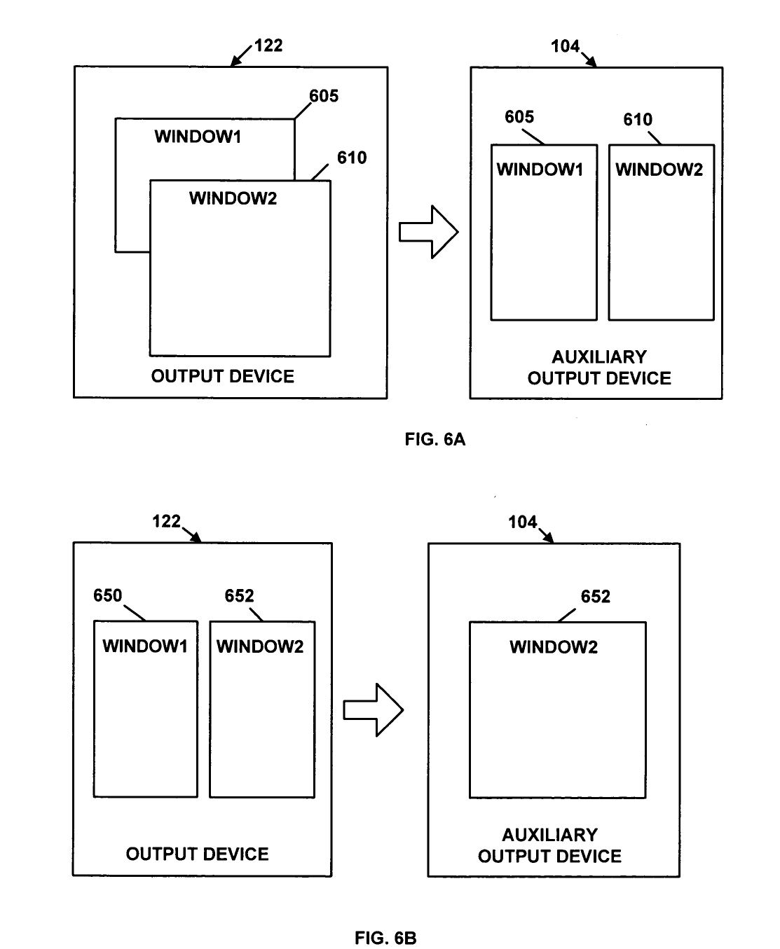

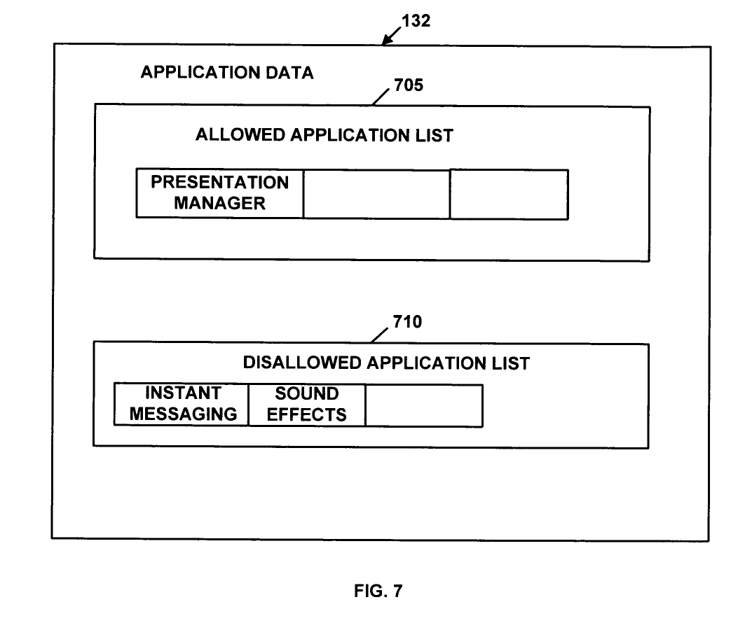

The presentation controller 126 determines the information to be sent from the application 128 to the auxiliary output device 104. In an embodiment, the presentation controller 126 includes instructions capable of executing on the processor 110 or statements capable of being interpreted by instructions executing on the processor 110 to present the user interfaces as further described below with reference to FIGS. 2, 6A, and 6B to create and manipulate the group data 130 as further described below with reference to FIG. 3, to create and manipulate the application data 132 as further described below with reference to FIG. 7, and to perform the functions as further described below with reference to FIGS. 4, 5, and 8. In another embodiment, the presentation controller 126 may be implemented in hardware via logic gates and/or other appropriate hardware techniques in lieu of or in addition to a processor-based system.

The application 128 may be any application that sends data to the output device 122. The presentation controller 126 may opt to send all of or a subset of the data from the application 128 to the auxiliary output device 104. In various embodiments, the application 128 may be a word processing application, an instant messaging application, a slide presentation generator (e.g., Microsoft PowerPoint), and/or any other appropriate application. The application 128 may include instructions that execute on the processor 110 or statements capable of being interpreted by instructions that execute on the processor 110. In another embodiments, the application 128 may be implemented via logic gates or other hardware in lieu of or in addition to a processor-based system.

The group data 130 characterizes the applications 128 into groups. In an embodiment, the presentation controller 126 uses the group data 130 to determine the subset of the displayed data on the output device 122 to send to the auxiliary output device 104. The group data 130 is further described below with reference to FIG. 3.

The application data 132 specifies which of the applications 128 are allowed to be shown on the auxiliary output device 104. In an embodiment, the presentation controller 126 uses the application data 132 to determine the subset of the windows displayed on the output device 122 to send to the auxiliary output device 104. The application data is further described below with reference to FIG. 7.

The input device 120 may be a keyboard, mouse or other pointing device, trackball, touchpad, touchscreen, keypad, microphone, voice recognition device, or any other appropriate mechanism for the user to input data to the electronic device 102 and/or to manipulate the user interfaces of the electronic device 102, such as the user interfaces further described below with reference to FIGS. 2, 6A, and 6B. Although only one input device 120 is shown, in another embodiment any number and type of input devices may be present.

The output device 122 is that part of the electronic device 102 that presents output to the user. The output device 122 may be a cathode-ray tube (CRT) based video display well known in the art of computer hardware. But, in other embodiments the output device 122 may be replaced with a liquid crystal display (LCD) based or gas, plasma-based, flat-panel display. In still other embodiments, any appropriate display device may be used. In other embodiments, a speaker or a printer may be used. In other embodiments any appropriate output device may be used. Although only one output device 122 is shown, in other embodiments, any number of output devices of different types or of the same type may be present. The output device 122 may display or otherwise present the user interfaces and the output of the presentation controller 126 and the applications 128, such as the user interfaces and output further described below with reference to FIGS. 2, 6A, and 6B.

The bus 125 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller). Although the bus 125 is shown in FIG. 1 as a relatively simple, single bus structure providing a direct communication path among the processor 110, the storage device 115, the input device 120, and the output device 122, in other embodiments the bus 125 may comprise multiple different buses or communication paths, which may be arranged in any of various forms, such as point-to-point links in hierarchical, star or web configurations, multiple hierarchical buses, or parallel and redundant paths. Furthermore, while the bus 125 is shown directly connected to the processor 110, the storage device 115, the input device 120, and the output device 122, in other embodiments, some or all of the I/O (Input/Output) devices may be connected via I/O processors.

The electronic device 102 may be implemented using any suitable hardware and/or software, such as a personal computer. Portable computers, laptop or notebook computers, PDAs (Personal Digital Assistants), pocket computers, telephones, pagers, automobiles, teleconferencing systems, appliances, and mainframe computers are examples of other possible configurations of the electronic device 102. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

In an embodiment, the auxiliary output device 104 may be a cathode-ray tube (CRT) based video display. In another embodiment the auxiliary output device 104 is implemented via a liquid crystal display (LCD) based or gas, plasma-based, flat-panel display. In another embodiment, the auxiliary output device 104 converts incoming video or graphic signals to light for projection on a screen, presentation wall, movie screen, or television screen. In an embodiment, the auxiliary output device 104 is implemented via a Digital Micromirror Device (DMD), which is a semiconductor that acts as a light switch consisting of many microscopic mirrors, each of which is able to tilt back and forth. In other embodiments any appropriate projector may be used. In still other embodiments, any appropriate display device may be used. Although two auxiliary output devices 104 are shown, in other embodiments, any number of auxiliary output devices 104 of different types or of the same type may be present. The auxiliary output device 104 may be connected to the electronic device 102 via any appropriate mechanism, whether hardwired or wireless.

The network 105 may be any suitable network or combination of networks and may support any appropriate protocol suitable for communication of data and/or code to/from the electronic device 102 and/or between the electronic device 102 and the auxiliary output device 104. In various embodiments, the network 105 may represent a storage device or a combination of storage devices, either connected directly or indirectly to the electronic device 102 and the auxiliary output device 104. In an embodiment, the network 105 may support Infiniband. In another embodiment, the network 105 may support wireless communications. In another embodiment, the network 105 may support hard-wired communications, such as a telephone line or cable. In another embodiment, the network 105 may support the Ethernet IEEE (Institute of Electrical and Electronics Engineers) 802.3×specification. In another embodiment, the network 105 may be the Internet and may support IP (Internet Protocol). In another embodiment, the network 105 may be a local area network (LAN) or a wide area network (WAN). In another embodiment, the network 105 may be a hotspot service provider network. In another embodiment, the network 105 may be an intranet. In another embodiment, the network 105 may be a GPRS (General Packet Radio Service) network. In another embodiment, the network 105 may be a FRS (Family Radio Service) network. In another embodiment, the network 105 may be any appropriate cellular data network or cell-based radio network technology. In another embodiment, the network 105 may be an IEEE 802.11B wireless network. In still another embodiment, the network 105 may be any suitable network or combination of networks. Although one network 105 is shown, in other embodiments any number of networks (of the same or different types) may be present.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the electronic device 102, and that, when read and executed by one or more processors in the electronic device 102, cause the electronic device 102 to perform the steps necessary to execute steps or elements embodying the various aspects of an embodiment of the invention.

Moreover, while embodiments of the invention have and hereinafter will be described in the context of fully functioning electronic devices, the various embodiments of the invention are capable of being distributed as a program product in a variety of forms, and the invention applies equally regardless of the particular type of signal-bearing medium used to actually carry out the distribution. The programs defining the functions of this embodiment may be delivered to the electronic device 102 via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, e.g., the network 105, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a pictorial representation of an example user interface 200, according to an embodiment of the invention, which is exemplary only and any appropriate interface and data may be used. The presentation controller 126 may present the user interface 200 via the output device 122. The user interface 200 includes various applications, such as applications 128-1, 128-2, 128-3, 128-4, and 128-5, each displayed in a respective window. Each of the applications 128-1, 128-2, 128-3, 128-4, and 128-5 includes a respective group identifier 280, 282, 284, 286, and 288. The group identifiers indicate the group affiliation to which the respective application belongs. The group identifier 288 is “H” which is a special identifier that indicates a group that is not to be sent to the auxiliary output device 104. The presentation controller 126 uses the groups to determine whether to send data displayed in the associated window to the auxiliary output device 104, as further described below with reference to FIGS. 3, 4, and 5. In an embodiment, if the user selects one of the group identifiers 280, 282, 284, 286, or 288 via the input device 120, the presentation controller 126 sends the associated group of windows to the auxiliary output device 104.

The user interface 200 also includes a taskbar 202, which includes icons 255, 260, 265, 270, and 275 for launching, accessing, and/or bringing into focus the respective applications 128-1, 128-2, 128-3, 128-4, and 128-5. Each of the icons includes a respective group identifier 290, 292, 294, 296, and 298 for indicating the group to which the application belongs.

The user may request the creation and deletion of groups, request the addition of the applications 128 to groups, request that a group or groups be sent to the auxiliary output device 104, and specify which group, if any, is to be hidden using the input device 120. The user may also request the launching of the applications and the bringing into focus of the windows associated with the applications via the input device 120.

FIG. 3 depicts a block diagram of an example data structure for the group data 130, according to an embodiment of the invention. The group data 130 includes records 310, 315, and 320, each associated with a respective group of applications, but in other embodiments any number of records with any appropriate data may be used. Each of the records includes a group identifier field 322, an applications field 325, a hidden field 330, and an on-projector field 340.

The group identifier field 322 indicates the group associated with the respective record. For example, the record 310 includes “1” in the group identifier field 322, which corresponds to the group identifiers 280 and 282 in FIG. 2; the record 315 includes “2” in the group identifier field 322, which corresponds to the group identifiers 284 and 286 in FIG. 2; and the record 320 includes “H” in the group identifier field 322, which corresponds to the group identifier 288 in FIG. 2. “H” is a special group identifier indicating that the group is hidden and is not to be displayed on the auxiliary output device 104, but in other embodiments any appropriate special group identifier may be used.

The applications field 325 indicates the application(s) 128 that belong to the respective group. For example, the record 310 includes “app1, app2” in the applications field 325, indicating that the applications 128-1 and 128-2 belong to the group having the group identifier 1; the record 315 includes “app3, app4” in the applications field 325, indicating that the applications 128-3 and 128-4 belong to the group having the group identifier 2; and the record 320 includes “app5” in the applications field 325, indicating that the application 128-5 belongs to the group having the group identifier “H.” A group may have any number of applications.

The hidden field 330 indicates whether the group is hidden, meaning the applications in the group are not to be displayed on the auxiliary output device 104. The records 310 and 315 include “no” in the hidden field 330, indicating that the applications associated with the respective groups may be shown on the auxiliary output device 104. The record 320 includes “yes” in the hidden field 330, indicating that the application associated with the group is hidden and is thus not to be sent to the auxiliary output device 104.

The on-projector field 340 indicates whether the applications associated with the group are currently displayed on the auxiliary output device 104. The records 310 and 320 include “no” in the on-projector field 340, indicating that the data from the associated applications are not currently being sent to the auxiliary output device 104. The record 315 includes “yes” in the on-projector field 340, indicating that data from the applications associated with the group is currently being sent to the auxiliary output device 104.

In the embodiment illustrated in FIG. 3, the group data 130 includes slide data 360, which the application 128 may use to display sides of a presentation. In another embodiment, the group data 130 is embedded in the slide data 360. In this way, the group data 130 is associated with the slide data 360, so that applications and their group affiliations may be tailored to a particular presentation and when the presentation is moved to another computer or electronic device, the group data 130 is also moved. In another embodiment the slide data 360 is optional or not present.

FIG. 4 depicts a flowchart of example processing for the presentation controller 126, according to an embodiment of the invention. Control begins at block 400. Control then continues to block 405 where the presentation controller 126 receives an event. Control then continues to block 410 where the presentation controller 126 determines whether the received event is a create group event, indicating that the user desires to create a group. If the determination at block 410 is true, then control continues to block 415 where the presentation controller 126 creates an entry in the group data 130, including initializing the group identifier field 322, the hidden field 330, and the on-projector field 340. Control then continues to block 420 where the presentation controller 126 optionally adds applications, such as the applications 128 to the applications field 325 in the newly created record in the group data 130. Control then returns to block 405, as previously described above.

If the determination at block 410 is false, then control continues to block 425 where the presentation controller 126 determines whether the received event is an add application to group event, indicating that the user desires to add a specified application to an already-existing group. If the determination at block 425 is true, then control continues to block 430 where the presentation controller 126 adds the specified application to the application field 325 in the record in the group data 130 that is associated with the specified group. Control returns to block 405, as previously described above.

If the determination at block 425 is false, then control continues to block 435 where the presentation controller 126 determines whether the event received at block 410 indicates that the user desires to delete an application from a pre-existing group. If the determination at block 435 is true, then control continues to block 440 where the presentation controller 126 deletes the specified application from the applications field 325 in the record in the group data 130 that is associated with the specified group.

If the determination at block 435 is false, then control continues to block 445 where the presentation controller 126 determines whether the event received at block 405 indicates that an application 128 has been launched or a window has been brought into focus. In an embodiment a window is brought into focus, so that it is ready to accept input, by the user selecting it with the input device 120 or by the user selecting one of the icons 255, 260, 265, 270, or 275 with the input device 120. If the determination at block 445 is true, then control continues to block 450 where the presentation controller 126 determines whether the application determined at block 445 is in the application field 325 of one of the records in the group data 130.

If the determination at block 450 is true, then control continues to block 455 where the presentation controller 126 determines whether the hidden field 330 in the record previously found at block 450 indicates that the group is to be kept hidden. If the determination at block 455 is true, then control continues to block 470 where the presentation controller 126 displays the window of the associated application 128 on the output device 122 only and does not send the window of the application 128 to the auxiliary output device 104. Thus, the presentation controller 126 uses the group affiliations to determine a subset of the windows displayed on the output device 122 to send to the auxiliary output device 104. Control then returns to block 405, as previously described above.

If the determination at block 455 is false, then control continues to block 460 where the presentation controller 126 sends the windows for all the applications indicated in the applications field 325 associated with the record to the auxiliary output device 104 in addition to sending the windows to the output device 122. Control then continues to block 465 where the presentation controller 126 updates the on-projector field 340 in the record to indicate that windows for the applications in the group are currently being displayed on the auxiliary output device 104 in addition to being displayed on the output device 122. Thus, in an embodiment, the presentation controller 126 uses the group affiliations and whether a window has been brought into focus to determine a subset of the windows displayed on the output device 122 to send to the auxiliary output device 104. In another embodiment, windows that are brought into focus are not sent to the auxiliary output device 104 until selected by the user, for example by the group identifier in the window, such as the group identifiers 280, 282, 284, 286, and 288 (FIG. 2), in order to allow the user to manipulate the newly in-focus window and/or position it properly before sending it to the auxiliary output device 104. Control then returns to block 405, as previously described above.

If the determination at block 450 is false, then control continues to block 470, as previously described above.

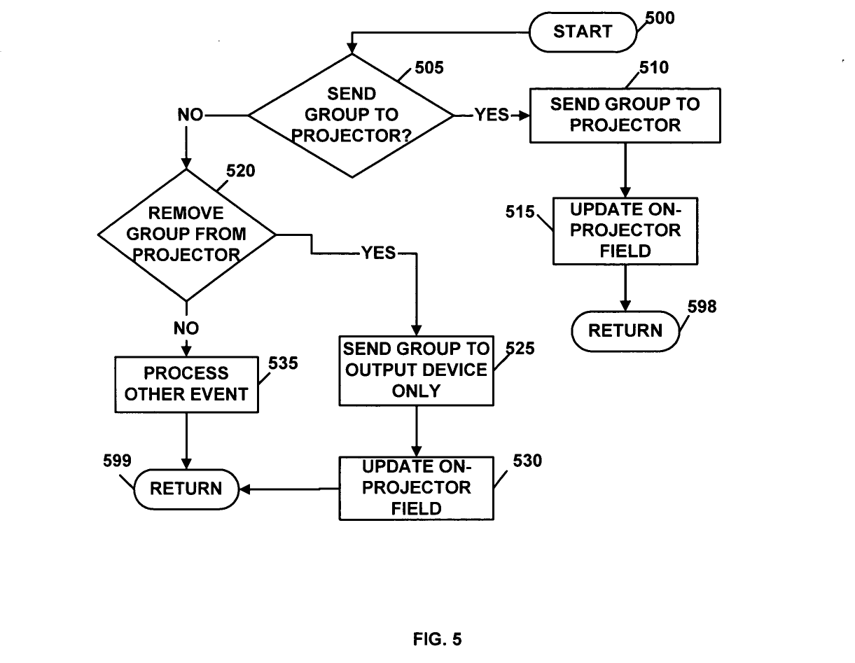

If the determination at block 445 is false, then control continues to block 475 where the presentation controller 126 processes other events, as further described below with reference to FIG. 5. Control then returns to block 405, as previously described above.

FIG. 5 depicts a flowchart of example processing for the presentation controller 126, according to an embodiment of the invention. Control begins at block 500. Control then continues to block 505 where the presentation controller 126 determines whether the event received at block 405 (FIG. 4) indicates that the user desires to send windows for a specified group to the auxiliary output device 104. In an embodiment, the user indicates that desire by selecting the group identifier in a window with the input device 120, such as one of the group identifiers 280, 282, 284, 286, and 288 (FIG. 2). If the determination at block 505 is true, then control continues to block 510 where the presentation controller 126 sends windows for all applications in the specified group to the auxiliary output device 104. Control then continues to block 515 where the presentation controller 126 updates the on-projector field 340 associated with the specified group to indicate that windows for all applications in the group are currently being sent to the auxiliary output device 104. In this way, the presentation controller 126 selects a subset of the windows displayed on the output device 122 to send to the auxiliary output device 104. Control then continues to block 598 where the function returns.

If the determination at block 505 is false, then control continues to block 520 where the presentation controller 126 determines whether the event received at block 405 (FIG. 4) indicates that the user desires to remove windows associated with a specified group from the auxiliary output device 104. If the determination at block 520 is true, then control continues to block 525 where the presentation controller 126 sends windows associated with the specified group to the output device 122 only and does not send windows for the specified group to the auxiliary output device 104. Control then continues to block 530 where the presentation controller 126 updates the on-projector field 340 to indicate that windows for the group is not currently sent to the auxiliary output device 104. In this way, the presentation controller 126 selects a subset of the windows displayed on the output device 122 to send to the auxiliary output device 104. Control then continues to block 599 where the function returns.

If the determination at block 520 is false, then control continues to block 535 where the presentation controller 126 processes any other events that are received at block 405 (FIG. 4). Control then continues to block 599 where the function returns.

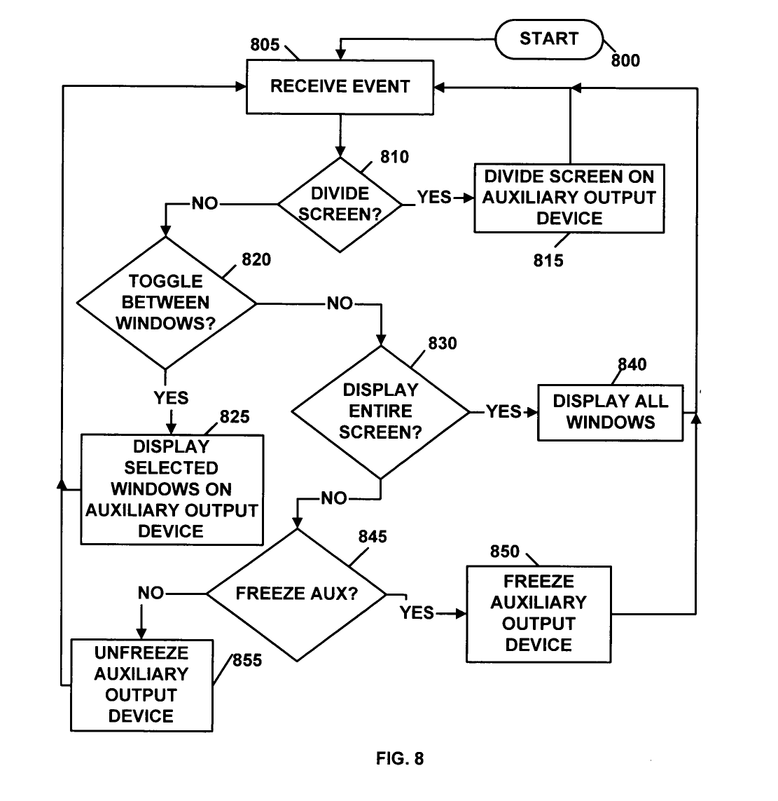

FIG. 6A depicts a pictorial representation of an example contents displayed on the output device 122 and example contents displayed on the auxiliary output device 104 using a divide function in the presentation controller 126. On the output device 122, the presentation manager displays a window 605 and a window 610, which overlap. But, when the presentation controller 126 sends the contents of the output device 122 to the auxiliary output device 104, the presentation controller 126 divides the screen in half and displays the window 605 and the window 610 side-by-side in a non-overlapping format. Although two windows 605 and 610 are illustrated, in other embodiments any number of windows may be displayed. Although the windows 605 and 610 are displayed side-by-side on the auxiliary output device 104, in other embodiments any non-overlapping format, overlapping format, or combination thereof may be used. In another embodiment, the data in the windows 605 and 610 on the output device 122 is scrollable, so that not all of the data in the windows is seen at the same time while the data in the windows 605 and 610 on the auxiliary output device 104 is displayed in a non-scrollable format, so that all of the data can be seen at once. In an embodiment, the presentation controller 126 resizes the data on the auxiliary output device 104 to make the data smaller, so that all of the data can be seen without needing to scroll. The divide function is further described below with reference to FIG. 8.

FIG. 6B depicts a pictorial representation of an example contents displayed on the output device 122 and example contents displayed on the auxiliary output device 104 using a toggle function in the presentation controller 126. On the output device 122, the presentation manager displays a window 650 and a window 652. But, when the presentation controller 126 sends the contents of the output device 122 to the auxiliary output device 104, the presentation controller 126 displays only the selected window 652. The toggle function is further described below with reference to FIG. 8. In other embodiments, any number of windows may be displayed on the output device 122 and any number of windows may selected and sent to the auxiliary output device 104. In this way, the presentation controller 126 selects a subset of the windows on the output device 122 and sends the subset to the auxiliary output device 104. In another embodiment, a window may be displayed on the auxiliary output device 104, but not on the output device 122.

FIG. 7 depicts a block diagram of an example data structure for the application data 132, according to an embodiment of the invention. The application data 132 includes an allowed application list 705, which includes a list of selected applications that are allowed to be displayed via the auxiliary output device 104. In another embodiment, the application data 132 includes a disallowed application list 710, which includes a list of selected applications that are not permitted to be displayed via the auxiliary output device 104. In various embodiments, the presentation controller 126 uses the allowed application list 705 or the disallowed application list 710 to select a subset of windows on the output device 122 to send to the auxiliary output device 104, as further described below with reference to FIG. 8.

FIG. 8 depicts a flowchart of example processing for the presentation controller 126, according to an embodiment of the invention. Control begins at block 800. Control then continues to block 805 where the presentation controller 126 receives an event. Control then continues to block 810 where the presentation controller 126 determines whether the event previously received at block 805 is a divide screen event. If the determination at block 810 is true, then control continues to block 815 where the presentation controller 126 divides the screen on the auxiliary output device 104 and sends information associated with the windows displayed on the output device 122 to separate areas of the divided screen on the auxiliary output device 104, regardless of the position of the windows on the output device 102, as previously described above with reference to FIG. 6A. Control then returns to block 805, as previously described above.

If the determination at block 810 is false, then control continues to block 820 where the presentation controller 126 determines whether the event previously received at block 805 is a toggle between windows event. If the determination at block 820 is true, then control continues to block 825 where the presentation controller 126 displays a selected window or windows on the auxiliary output device 104. In an embodiment, the presentation controller 126 sends only those windows in the allowed application list 705 to the auxiliary output device 104. In another embodiment, the presentation controller 126 sends all currently active windows at the output device 122 to the auxiliary output device 104 except for those windows in the disallowed application list 710. In this way, the presentation controller 126 selects a subset of the windows displayed on the output device 122 to send to the auxiliary output device 104. Control then returns to block 805, as previously described above.

If the determination at block 820 is false, then control continues to block 830 where the presentation controller 126 determines whether the event previously received at block 805 is a display the entire screen event. If the determination at block 830 is true, then control continues to block 840 where the presentation controller 126 sends all the windows active on the output device 122 to the auxiliary output device 104. Control then returns to block 805 as previously described above.

If the determination at block 830 is false, then control continues to block 845 where the presentation controller 126 determines whether the event previously received at block 850 is a freeze projector event. In an embodiment, the freeze projector event is initiated by the user via the input device 120. In another embodiment, the freeze projector event is initiated automatically when the electronic device 102 powers on. If the determination at block 845 is true, then control continues to block 850 where the presentation controller 126 freezes the information sent to the auxiliary output device 104 and repeatedly sends the information that was displayed on the output device 122 at the time of the freeze event to the auxiliary output device 104. In another embodiment, the presentation controller 126 sends a special frame or pre-set image to the auxiliary output device 104, which may be especially helpful, e.g., at power on time while the user is performing setup tasks prior to starting the presentation. Control then returns to block 805, as previously described above.

If the determination at block 845 is false, then control continues to block 855 where the presentation controller unfreezes the information sent to the auxiliary output device 104. Control then returns to block 805, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

1. A method comprising:
presenting a plurality of windows on an output device;
selecting a subset of the plurality of windows; and
sending the subset to an auxiliary output device.

2. The method of claim 1, wherein the auxiliary output device comprises a projector.

3. The method of claim 1, wherein the selecting further comprises:
selecting the subset based on group affiliations of the plurality of windows.

4. The method of claim 1, wherein the selecting further comprises:
selecting the subset based on a list of allowed applications.

5. The method of claim 1, wherein the selecting further comprises:
selecting the subset based on a list of disallowed applications.

6. The method of claim 1, wherein the selecting further comprises:
detecting that an application has launched; and
determining whether the application belongs to a group.

7. The method of claim 1, wherein the selecting further comprises:
detecting that an application has been brought into focus; and
determining whether the application belongs to a group.

8. The method of claim 1, further comprising:
changing the subset that is sent to the auxiliary output device.

9. An apparatus comprising:
means for presenting a plurality of windows on an output device;
means for selecting a subset of the plurality of windows;
means for sending the subset to an auxiliary output device; and
means for refraining from sending windows not in the subset to the auxiliary output device.

10. The apparatus of claim 9, wherein the auxiliary output device comprises a projector.

11. The apparatus of claim 9, wherein the means for selecting further comprises:
means for selecting the subset based on group affiliations of the plurality of windows.

12. The apparatus of claim 11, further comprising:
means for displaying the group affiliations in the respective windows.

13. The apparatus of claim 9, wherein the means for selecting further comprises:
means for detecting that an application has launched; and
means for determining whether the application belongs to a group.

14. The apparatus of claim 9, wherein the means for selecting further comprises:
means for detecting that an application has been brought into focus; and
means for determining whether the application belongs to a hidden group.

15. A signal-bearing medium encoded with instructions, wherein the instructions when executed comprise:
sending an image to both an output device and an auxiliary output device; and
changing the image on the output device to a new image while freezing the image on the auxiliary output device.

16. The signal-bearing medium of claim 15, wherein the auxiliary output device comprises a projector.

17. The signal-bearing medium of claim 15, further comprising:
unfreezing the image on the auxiliary output device.

18. The signal-bearing medium of claim 15, wherein the freezing the image further comprises:
re-transmitting the image to the auxiliary output device.

19. The signal-bearing medium of claim 15, wherein the freezing the image further comprises:
transmitting a pre-set image to the auxiliary output device.

20. The signal-bearing medium of claim 17, wherein the unfreezing the image further comprises:
sending the new image to the auxiliary output device.

21. An electronic device comprising:
a processor; and
a storage device encoded with instructions, wherein the instructions when executed on the processor comprise:
displaying a plurality of windows on an output device, wherein at least some of the plurality of windows overlap, and
displaying the plurality of windows on an auxiliary output device in a non-overlapping format.

22. The electronic device of claim 21, wherein the windows that overlap include data in a scrollable format and the windows in the non-overlapping format include the data in a non-scrollable format.
